(19) United States
(12) Patent Application Publication
(10) Pub. No.: US 2012/0148772 A1
(43) Pub. Date: Jun. 14, 2012

(54) TEXTILE SLEEVE WITH PROTECTIVE COATING AND METHOD OF CONSTRUCTION THEREOF

(76) Inventors: Ramesh R. Avula, Phoenixville, PA (US); Cassie M. Malloy, Blue Bell, PA (US); Ellen M. Bacon, Blue Bell, PA (US)

(21) Appl. No.: 13/314,289

(22) Filed: Dec. 8, 2011

Related U.S. Application Data
(60) Provisional application No. 61/420,991, filed on Dec. 8, 2010.

(51) Int. Cl. B32B 1/08; D04B 9/00; D06B 1/00; D04C 1/06; B32B 1/06; B32B 38/00

(52) U.S. Cl. 428/36.1; 156/215; 28/169; 87/6; 87/7; 66/8

(57) ABSTRACT

A coated textile sleeve for routing and protecting elongate members, combination thereof, and method of construction is provided. The textile sleeve has an elongate knit wall constructed from weft knit yarns. The knit wall has an inner surface providing a generally tubular cavity in which the elongate members are received and protected. The inner surface is formed, at least in part, by laid-in yarn to provide a soft, non-abrasive surface for dampening contact with the elongate members being protected to facilitate absorbing vibration, which in turn, reduces the frictional wear of the elongate members being protected. Further, the knit wall has an outer surface with a flexible, impervious elastomeric coating thereon. The elastomeric coating allows the knit wall to substantially retain its flexibility as knit, provides enhanced protection against the ingress of fluid and other contaminants, and providing added dampening to absorb vibration.

### CROSS-REFERENCE TO RELATED APPLICATION

This application claims the benefit of U.S. Provisional Application Ser. No. 61/420,991, filed Dec. 8, 2010, which is incorporated herein by reference in its entirety.

### BACKGROUND OF THE INVENTION

1. Technical Field

This invention relates generally to textile sleeves for protecting elongate members, and more particularly to knit sleeves having a protective coating.

2. Related Art

It is known to wrap wires and wire harnesses in protective sleeves, such as in automobiles, aircraft or aerospace craft, to provide protection to the wires against abrasion, fluid and thermal effects. In order to achieve the desired protection, the protective sleeve may have multiple layers, with some of the layers being specifically provided for different types of protection. For example, one layer may be provided for water resistance, e.g. a sheet of plastic material, while another layer may be provided for abrasion resistance, and yet another layer may be provided for protection against thermal conditions, e.g. a non-woven layer. Unfortunately, although the aforementioned multilayer sleeves may provide suitable protection against the various external environmental conditions, they can be abrasive to the outer surface of the elongate members being protected, and are typically bulky, thereby being relatively heavy and exhibiting limited flexibility. This can prove problematic in some applications, particularly applications requiring routing through tight, winding areas, and applications having weight restrictions, such as aircraft and aerospace applications, for example. In addition, multilayered sleeves typically come at an increased cost given the intricacies and special requirements needed in construction of the individual layers.

### SUMMARY OF THE INVENTION

One aspect of the invention includes a coated textile sleeve for routing and protecting elongate members from exposure to abrasion, thermal conditions, vibration and other environmental conditions, such as exposure to fluid. The textile sleeve has an elongate knit wall constructed from weft knit yarns. The knit wall has an inner surface providing a generally tubular cavity in which the elongate members are received and protected. The inner surface is formed, at least in part, by laid-in yarn to provide a soft, non-abrasive surface for dampening contact with the elongate members being protected to facilitate absorbing vibration, which in turn, reduces the frictional wear of the elongate members being protected. Further, the knit wall has an outer surface with a flexible impervious elastomeric coating thereon. The elastomeric coating allows the knit wall to retain its flexibility as knit, while also providing enhanced protection against the ingress of fluid and other contaminants, while at the same time providing a dampening property to facilitate absorbing vibration, which in turn, reduces the frictional wear of the elongate members being protected.

In accordance with another aspect of the invention, a textile wall is overlaid about the elastomeric coating. The overlaid textile wall provides added protection against possible damage from surrounding environment debris, while allowing the underlying textile wall to substantially retain its flexibility as knit.

In accordance with another aspect of the invention, a textile sleeve in combination with an elongate member received therein is provided. The textile sleeve includes an elongate inner wall of weft knit yarn. The inner wall has an inner surface and an outer surface. The inner surface provides a generally tubular cavity in which the elongate member is received and includes, at least in part, laid-in yarn that provides a dampening, non-abrasive surface for contact with the elongate member. A flexible, impervious, elastomeric coating is bonded on the outer surface of the inner wall to prevent the ingress of fluid into the cavity. Further, at least some of the laid-in yarn is bonded to the elongate member, thereby inhibiting relative movement between the inner wall and the elongate member.

In accordance with another aspect of the invention, a textile outer wall is disposed about the elastomeric coating with the elastomeric coating being sandwiched between the inner wall and the outer wall.

In accordance with another aspect of the invention, a method of constructing a coated textile sleeve is provided for routing and protecting elongate members. The method includes weft knitting an elongate wall and laying-in yarn to form at least a portion of an inner surface of the wall during the weft knitting to provide a soft, non-abrasive inner surface for dampening contact with the elongate members being protected. Further, the method includes coating an outer surface of the weft knit wall with a flexible impervious elastomeric coating while substantially maintaining the flexibility of the weft knit wall.

In accordance with another aspect of the invention, the method further includes providing added protection against possible damage from environment debris about the elastomeric coating by overlaying a textile wall about the elastomeric coating, while at the same time allowing the underlying knit textile wall to substantially retain its flexibility.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a schematic side view of a coated textile sleeve constructed in accordance with one aspect of the invention carrying and protecting elongate members therein; and

FIG. 2 is a schematic cross-sectional view of the sleeve of FIG. 1 taken generally along the line 2-2.

### DETAILED DESCRIPTION OF PREFERRED EMBODIMENTS

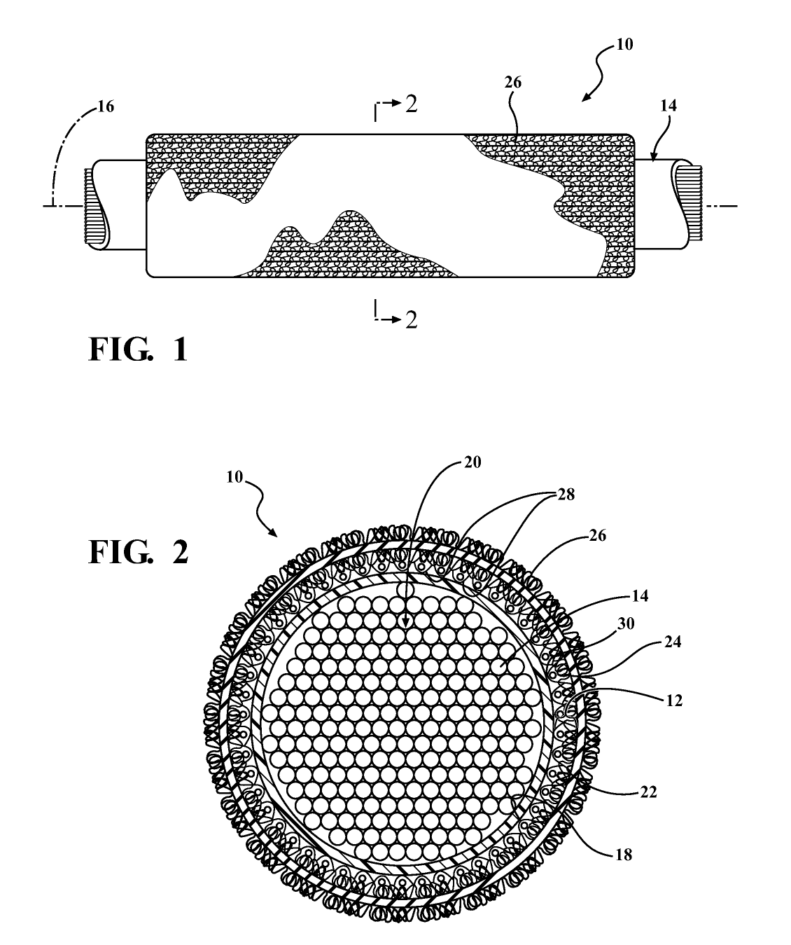

Referring in more detail to the drawings, FIG. 1 shows a schematic side view of coated textile sleeve, referred to hereafter as sleeve 10, constructed in accordance with one aspect of the invention. The sleeve 10 has an elongate inner textile wall 12 (FIG. 2) for routing and protecting elongate members, such as wires or a wire harness 14, for example, from exposure to abrasion, and other environmental conditions, such as exposure to fluid. The elongate wall 12 extends along a longitudinal central axis 16 and has an inner surface 18 bounding an inner cavity 20, wherein the inner surface 18 is configured to provide a soft, dampening, non-abrasive surface against the elongate member(s) 14 being protected and outer surface. The textile wall 12 also has an outer surface 22 with an impervious elastomeric coating 24 bonded thereto to provide the wall 12 with a liquid impervious property, such that the elongate member(s) 14 are protected against liquid contamination that may be present outside the sleeve 10 and in contact with the coating 24. Accordingly, the textile wall 12 provides the sleeve 10 with a strong, durable, property, while also providing the soft, cushioning inner surface 18 against the elongate members 14. Further, the coating 24 provides the sleeve 10 with an impervious barrier to liquid, thus keeping any liquid outside the sleeve 10 from entering the cavity 20, while at the same time allowing the wall 12 to retain or substantially retain its flexibility, such as may be needed for routing purposes.

In accordance with yet another aspect of the construction of the sleeve 10, an outer textile wall 26 can be overlaid on and about the coating 24, wherein the outer wall 26 provides added abrasion resistance protection to the sleeve 10, and in particular, protects the elastomeric coating 24 from being damaged by external debris.

The inner textile wall 12 is constructed by interlacing yarns in a circular knitting process to interlink the yams with knit stitches. During the circular weft knitting process, in addition to interlinking yarns with the desired type of knit stitch, at least one end of yam is weft inserted, also referred to as being laid-in, with the laid-in yarn 28 providing at least a portion of, or the entire or substantially entire inner surface 18. Some preferred knitting processes used are a sliver weft knit process and a tuck-and-float weft knitting process. In both of these weft knitting processes, the laid-in yam 28 provides a soft, cushion, dampening surface against which the elongate members 14 abut. To facilitate providing the soft cushion desired, at least some of the laid-in yam 28 can be provided as relatively bulky yam. As such, the potential for abrasion and vibration between the inner surface 18 and the elongate members 14 is minimized. In addition, some of the laid-in yarn 28 forming the inner surface 18 can include a polymeric low melt yarn, wherein the low melt yarn can be heated to melt or at least partially melt and bond at least a portion of the inner surface 18 via a bond/weld joint 30 to the elongate member 14, further reducing the potential for abrasion between the inner surface 18 and the elongate member 14. By way of example and without limitation, some materials that could be used include materials with good recovery, e.g. Nylon; materials having good flex fatigue, e.g. P-Aramid; and materials having high energy or electrical charge dissipation properties within the elongate member 14, wherein the energy can be absorbed and then removed from the sleeve 10. To enhance the ability of the sleeve 10 to flex, the outer surface 22 of the wall 12 can be formed having circumferentially extending annular ribs, in a corrugated configuration, formed via weft yarns having different diameters, and of different materials, if desired for the intended environment.

The elastomeric coating layer 24 is adhered to the outer surface 22 of the inner textile wall 12, such as in a dipping or spraying process, by way of example and without limitation. The coating layer 24, in addition to providing an impervious barrier to fluid, such as water, for example, adds durability while remaining flexible. In addition, the layer 24 can be formulated to provide electrical insulation to the elongate members 14, thus, reducing a potential for electromagnetic interference (EMI).

The outer textile wall 26 is overlayed on the coating layer 24, such as in an over-braiding or over-knitting process. As such, the outer textile wall 26 can have interlinked braided yarns or interlinked knit stitches. Regardless, both the braided or knit outer textile wall 26 has a multi-axis flexibility, thereby allowing the sleeve 10 to retain a high degree of flexibility in all directions. It should be recognized that the outer textile wall 26 can be formed using any desired materials of monofilament and/or multifilament yarn, as desired for the intended application, including heat resistant materials for extreme heat applications.

Obviously, many modifications and variations of the present invention are possible in light of the above teachings. It is, therefore, to be understood that within the scope of the appended claims, the invention may be practiced otherwise than as specifically described.

What is claimed is:

1. A textile sleeve for routing and protecting elongate members, comprising:
an elongate textile inner wall of weft knit yarn, said wall having an inner surface and an outer surface, said inner surface providing a generally tubular cavity in which the elongate members are received, said inner surface including, at least in part, laid-in yarn that provides a dampening, non-abrasive surface for contact with the elongate members; and
an impervious elastomeric coating on said outer surface of said inner wall.

2. The textile sleeve of claim 1 further including a textile outer wall disposed on said elastomeric coating with said elastomeric coating being sandwiched between said inner wall and said outer wall.

3. The textile sleeve of claim 2 wherein the textile outer wall is braided.

4. The textile sleeve of claim 2 wherein the textile outer wall is knit.

5. The textile sleeve of claim 1 wherein at least some of said laid-in yarn is a low melt polymeric yarn.

6. A textile sleeve in combination with an elongate member received therein, comprising:
an elongate inner wall of weft knit yam, said inner wall having an inner surface and an outer surface, said inner surface providing a generally tubular cavity in which said elongate member is received, said inner surface including, at least in part, laid-in yam that provides a dampening, non-abrasive surface for contact with said elongate member;
an impervious elastomeric coating on said outer surface of said inner wall; and
at least some of said laid-in yarn being bonded to said elongate member.

7. The combination of claim 6 further including a textile outer wall disposed on said elastomeric coating with said elastomeric coating being sandwiched between said inner wall and said outer wall.

8. The combination of claim 6 further including a weld joint bonding at least some

8. A method of constructing a textile sleeve for routing and protecting elongate members, comprising:
weft knitting a tubular inner wall having an inner surface bounding an inner tubular cavity and an outer surface, and inserting weft yams during the weft knitting to form at least a portion of the inner surface; and
applying an elastomeric coating on the outer surface of the tubular inner wall.

9. The method of claim 8 further including forming a textile outer wall on the coating with the coating being sandwiched between the inner and outer textile walls.

10. The method of claim 9 further including braiding the outer wall.

11. The method of 9 claim further including knitting the outer wall.

12. The method of claim 8 further including forming the inner wall using a circular weft knitting process.

13. The method of claim 8 further including inserting a low melt polymeric yarn to form at least a portion of the inner surface.

14. The method of claim 8 further including forming the inner wall using a sliver weft knit process.

15. The method of claim 8 further including forming the inner wall using a tuck-and-float weft knit process.
